(19) United States
(12) Patent Application Publication
(10) Pub. No.: US 2024/0161074 A1
(43) Pub. Date: May 16, 2024

(54) AUTOMATIC BANKING PAYMENTS

(71) Applicant: Bank of America Corporation, Charlotte, NC (US)

(72) Inventors: Lalit Dhawan, Cranbury, NJ (US); Manu Kurian, Dallas, TX (US); Kathy E. Robbins, Charlotte, NC (US); Stanley J. Schwartz, Wesley Chapel, NC (US); Radha Karuppannan, Huntersville, NC (US)

(21) Appl. No.: 17/986,098

(22) Filed: Nov. 14, 2022

(51) Int. Cl. G06Q 20/10; G06Q 20/14; G06Q 20/40

(52) U.S. Cl. CPC G06Q 20/102; G06Q 20/14; G06Q 20/40145

(57) ABSTRACT

Apparatus and methods for an intelligent and automatic bill payment decisor are provided. A program may receive two or more bills payable by a user and including information. The program may provide two or more selectable wealth-creation goals to the user and receive the user's selection. The program may also receive access to an account belonging to the user. The program may analyze the two or more bills, the selected wealth-creation goals, the user account, and other information to determine which bill to pay first and in what amount. The program may then transfer funds from the user's account to pay the bill(s) as determined. The program may also negotiate with the payment recipient(s). The program may also pay one or more bills with a revolving line-of-credit.

### FIELD OF TECHNOLOGY

Aspects of the disclosure relate to providing apparatus and methods to automatically decide which accounts/debts/payments to pay and apply payments to the chosen accounts/debts/payments.

### BACKGROUND OF THE DISCLOSURE

Many individuals, and entities, may have multiple accounts with different payment amounts and payment due dates. These accounts may all be serviced by different financial institutions. For example, an individual may have two credit cards, a mortgage, a personal loan, a car payment, and a dentist bill to pay in a particular month. Each of these accounts/debts/payments may be due on a different date of the month and for a different amount.

Managing each of these payments may be cumbersome as multiple accounts and payment methods may be involved. Individual payments may be applied late or in incorrect amounts. In addition, paying in full on or before a due date may be inefficient and leave wealth-creation opportunities behind. For example, it may be more cost-effective to pay a minimum amount (instead of the full amount) on a zero or low-interest loan/balance and apply the remainder to a higher-interest rate investment.

Alternatively, an individual or entity may not be able to pay every bill in full on a designated due date, and the individual or entity may have to prioritize which bill should be paid first and which bill should not be paid.

Currently, there is no apparatus or method available to automatically determine which payments to make, apply those payments, and adjust for various goals.

Therefore, it would be desirable for apparatus and methods to automatically determine which payments out of a plurality of bills due to pay, apply those payments, and adjust for various goals.

### SUMMARY OF THE DISCLOSURE

It is an object of this disclosure to provide apparatus and methods to automate bill payment decisions and bill payments.

An automatic bill payment decisor computer program product is provided. The computer program product may include executable instructions. The executable instructions may be stored on non-transitory memory.

The executable instructions may be executed by a processor on a computer system. The program may receive two or more bills. Each bill may originate from a distinct source. Each bill may be payable by a user. Each bill may include data specifying an amount, a payment recipient, a payment due date, payment information, as well as other information.

The program may provide two or more selectable wealth-creation goals to the user. The user may select one or more of the wealth-creation goals and the program may receive the user's selection.

The program may receive access to a user account that includes funds owned by the user.

The program may determine, through one or more artificial intelligence/machine learning (“Ai/ML”) algorithms, a determination of which one of the two or more bills to pay first as well as a payment amount to pay, as well as other determinations. The determination may analyze each of the two or more bills and the selected wealth creation goal(s). The program may make its determination(s) to satisfy the selected one or more wealth creation goals by determining a payment amount and order of payment.

The program may transfer the payment amount from the user's account to the appropriate payment recipient.

In an embodiment, each of the two or more bills may also include data specifying an interest rate and late fee.

In an embodiment, the computer program product may also receive access to a revolving line of credit. In an embodiment, the payment amount may be transferred from the revolving line of credit to the user account (adding to the funds available) and then to the payment recipient.

In an embodiment, one or more distinct source of one or more of the two or more bills may be a dentist provider, e.g., a doctor, a hospital, or a dentist.

In an embodiment, the computer program product may receive access to a wellbeing-savings account (“HSA”), which may be used to pay wellbeing related bills. In an embodiment, the payment amount may be transferred from the HSA to the user account and then to the payment recipient, for a wellbeing bill.

In an embodiment, the computer program product may also analyze past payment history of the user to make its determination(s).

In an embodiment, the computer program may be encrypted.

In an embodiment, each distinct source may be a separate source financial institution. For example, one credit card may be from one bank, a second card may be from a different bank, and a third card may be a store card.

In an embodiment, the user account may be located within a different financial institution than any source financial institution. For example, the user account may be with bank A, while each credit card may be from bank B, bank C, and store D, respectively.

In an embodiment, the program may automatically negotiate with each distinct source to procure one or more favorable terms for the user. For example, the program may negotiate a later due date, a lower penalty, a lower interest rate, or even a lower total amount due, among other favorable terms. In an embodiment, the negotiation may be with a distinct source computer. In an embodiment, the negotiation may be with an individual employed by, contracted with, or located at the distinct source.

In an embodiment, the program may automatically search a network for a funding source for the user. The network may be the Internet. For example, if the user's account balance is too low to satisfy the goal(s) selected by the user, the program may search for, find, apply for, and receive alternate funding (e.g., a loan or line of credit) for the user.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative schematic in accordance with principles of the disclosure.

FIG. 4 shows an illustrative schematic in accordance with principles of the disclosure.

FIG. 5 shows an illustrative flowchart in accordance with principles of the disclosure.

FIG. 6A shows an exemplary display screen in accordance with principles of the disclosure.

FIG. 6B shows an exemplary display screen in accordance with principles of the disclosure.

FIG. 6C shows an exemplary display screen in accordance with principles of the disclosure.

### DETAILED DESCRIPTION OF THE DISCLOSURE

It is an object of this disclosure to provide apparatus and methods to automate bill payment decisions and bill payments.

An automatic bill payment decisor computer program product is provided. The computer program product may include executable instructions. The executable instructions may be stored on non-transitory memory.

The executable instructions may be executed by a processor on a computer system. Multiple processors may increase the speed and capability of the program. The executable instructions may be stored in non-transitory memory on the computer system or a remote computer system, such as a server.

Other standard components of a computer system may be present. The computer system may be a server, mobile device, or other type of computer system. A server or more powerful computer may increase the speed at which the computer program may run. Portable computing devices, such as a smartphone, may increase the portability and usability of the computer program, but may not be as secure or as powerful as a server or desktop computer.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The computer may include a communication link, a processor or processors, and a non-transitory memory configured to store executable data configured to run on the processor, among other components. The executable data may include an operating system and the transaction classifying computer program.

A processor(s) may control the operation of the apparatus and its components, which may include RAM, ROM, an input/output module, and other memory. The microprocessor may also execute all software running on the apparatus. Other components commonly used for computers, such as EEPROM or Flash memory or any other suitable components, may also be part of the apparatus.

A communication link may enable communication with other computers as well as any server or servers. The communication link may include any necessary hardware (e.g., antennae) and software to control the link. Any appropriate communication link may be used. In an embodiment, the network used may be the Internet. In another embodiment, the network may be an internal intranet.

The computer system may be a server. The computer program may be run on a smart mobile device. The computer program, or portions of the computer program may be linked to other computers or servers running the computer program. The server or servers may be centralized or distributed. Centralized servers may be more powerful and secure than distributed servers but may also be more expensive.

The program may receive two or more bills. Each bill may be transmitted or uploaded to the program by a user. Each bill may be transmitted or uploaded by the payment recipient, source of the bill, or an agent of the above. A bill may be entered by typing in data included on the bill (such as an amount due and recipient), by scanning the bill and uploading the scan, by taking a picture of the bill and uploading the picture, by retrieving data from a different server or repository, or by any other appropriate method.

In an embodiment, the program may data mine a database, memory, a network, the Internet, or other computerized location for bills payable by a user. For example, the program may request (and receive permission to) access a user's email inbox. The program may automatically mine that email inbox for bills or bill equivalents.

In an embodiment, one or more of the bill(s) may be a recurring payment due, such as a mortgage or car loan/lease. The recurring payment due may have a beginning date and an end date as well as a number of payments due. The recurring payment due may have a fixed value or a variable value. The user or the program may receive the first bill in the recurring payment, a bill in the middle of the total payments, or the last bill in the recurring payment schedule.

In an embodiment, one or more of the bills may be a payoff amount of a recurring payment bill.

In an embodiment, the program may request a payoff amount of a bill or set of bills (e.g., a mortgage or car loan payoff amount) automatically. The request may be made to incorporate the payoff amount within an analysis by the program as an additional data point to analyze.

Each bill may originate from a distinct source. Each source may be the issuer of the bill (e.g., the person or entity providing the goods or services that now need to be paid for). One or more of the bills may have the same source. The source may be the payment recipient. The source may be an agent of the payment recipient (e.g., a bill collector). The source may be a financial institution (e.g., a credit card issued by a particular financial institution).

Each bill may be payable by a user. In an embodiment, one or more of the bills may be payable by someone else other than the user. For example, the user may offer to pay a particular bill for someone else.

Each bill may include data specifying an amount due, a payment recipient (e.g., who or what to make a check payable to), a payment due date, payment information (e.g., how to make the payment, such as a website, a phone number, or a mailing address), late payment penalty, interest rate, as well as other information. The more data included within each bill, the more data points the program may be able to analyze to determine an optimal course of action to satisfy a wealth creation goal selected by the user.

The program may provide two or more selectable wealth-creation goals to the user. The goals may be selectable through a graphical user interface (e.g., through a button click or checkbox). The goals may be selectable through an audiovisual interface (e.g., the user may state “yes” or “no” to each goal). The selected goals may be ranked in importance by the user. These goals may be transmitted periodically to the user (e.g., every month or every year), every time the user uploads a bill, or when the user registers an account with the program.

The wealth creation goals may include options such as: payoff every debt, make minimum payments, pay higher interest debt first, maximize savings, attempt to negotiate every bill, pay a bill on a certain date, pay bills on the due date, pay bills the day before a due date, pay bills as soon as possible (i.e., as soon as funds are available), pay bills as late as possible, pay bills with a line-of-credit before savings, as well as other wealth creation goals.

The wealth creation goals list may change or be variable. The wealth creation goals list may be static. The wealth creation goals list may change depending on the bills provided to the program, the account(s) provided to the program, past history of the user, or other variables.

The goals may be displayed on a list, on separate pages (that the user, for example, may swipe through), and may include various explanations and details for the user to review. The goals may be transmitted by the program to a device belonging to the user, or available to the user so that the user may view/listen to the goals and make a selection.

The user may select one or more of the wealth-creation goals by, for example, clicking a selection button or through another selection method. The program may limit the user's selections to any number less than the entire list. That is, the selection of goals may run the range from 1 to n−1, where n is the total number of goals provided to the user. In an embodiment, the n may be variable depending on which goal is selected. For example, certain goals may be incompatible with each other and if the user selects one of these incompatible goals, the other incompatible goals may become grayed out, struck through, or display some other indicator that the user cannot select these incompatible goals.

In an embodiment, the program may request the user rank the wealth creation goals in an order important to the user or provide an importance value between 0 and 10 for each goal. The program may utilize these rankings in its analysis.

The program may receive the user's selection. The user's selection of one or more goals may be transmitted from the user's device or other device available to the user back to the program. Any appropriate transmission protocol may be used.

The program may receive access to one or more user accounts that includes funds owned by the user. The user may provide this access when registering or setting up the program. The user may provide access around the same time the user selects one or more goals. The user may provide access when transmitting or uploading the one or more bills. The access may be limited to the program. The access may be limited in that the program may withdraw funds but not add funds. The access may be limited in that the program may have a withdrawal limit for a particular account.

In an embodiment, the access may be time-limited. For example, the access may expire the day after the last of the provided bills is due. Or, the access may expire at some pre-determined time after the access was provided (e.g., one day, 30 minutes, one hour, etc.). In an embodiment, the user may select the pre-determined time limit when providing access to the account.

Access to an account may include usernames, passwords, identifying information, authority, as well as any other required information. Each account may have different required information to grant access to the program.

The program may determine, through one or more artificial intelligence/machine learning (“AI/ML”) algorithms, a determination of which one of the two or more bills to pay first as well as a payment amount to pay, as well as make other determinations. The determination may analyze the data of each of the two or more bills, such as due amounts, interest rates, date due, and other data. The analysis should also include the selected wealth creation goal(s). Any appropriate AI/ML algorithm or combination of algorithms may be used. An intelligent optimizer algorithm may be used. The algorithm(s) may analyze past history, funds available, bill details, and other information to determine appropriate payment amounts and times to satisfy the selected goal(s) to a predetermined threshold value, such as 75% or 90% or 100%.

When the program cannot determine an optimal path to satisfy the selected goal(s), the program may inform the user and await instructions. Alternatively, the program may lower the threshold value until its determinations can meet the lower threshold value.

The program may make its determination(s) to satisfy the selected one or more wealth creation goals by determining a payment amount and order of payment. For example, if the selected goal was to pay each bill in full, on time, the program may determine which bill is due first and pay that one first. If the selected goal is to pay the minimum amount(s) due as funds become available, the analysis may determine which account has funds available to pay the minimum amount due for the closest due date.

The analysis and determinations may be repeated iteratively and over time, until the goal(s) are satisfied and/or all of the received bills are paid in full.

After determining an appropriate payment amount for the selected goal(s), the program, with its access to the user's account, may transfer the payment amount from the user's account to the appropriate payment recipient. The transfer may be through a paper check (which may be printed and mailed to the recipient), an e-check, an e-deposit, an electronic debit, a credit card payment, ACH withdrawal, or other appropriate payment method.

In an embodiment, the program may determine the appropriate payment method through its analysis of the selected goal(s) and the bill data.

In an embodiment, each of the two or more bills may also include data specifying an interest rate and late fee. Other information may also be included, such as a description of services rendered or goods provided. A description of goods/services may assist the program in determining an appropriate account to pay from, or a particular negotiation strategy.

In an embodiment, the computer program product may also receive access to a revolving line of credit or other funding source available to the user. The revolving line of credit or other funding source may be a credit card, loan, home equity line of credit, or other type of loan. Details of the other funding source may be transmitted to the program by the user. In an embodiment, the user may apply for a new funding source in response to the program being incapable of satisfying the selected goals without additional funds. In an embodiment, the program may apply for (and receive) a new funding source on behalf of the user.

In an embodiment, the payment amount may be transferred from the revolving line of credit or other funding source to the user account (adding to the funds available) and then to the payment recipient. In an embodiment, the program may pay the payment recipient directly from the other funding source.

The transfer of funds may be done electronically or through a printed check. Any method of electronic transfer may be used, such as direct deposit, e-check, ACH withdrawal, or other methods.

In an embodiment, one or more distinct source of one or more of the two or more bills may be a wellbeing provider, e.g., a doctor, a hospital, or a dentist. The program may analyze each bill to categorize each distinct source (e.g., as coming from a doctor's office, or as a tax bill, or a credit card bill, etc.). The program may automatically search a database or network (such as the Internet) for information about each distinct source/payment recipient. The user or other (person or entity) which uploaded the bill may indicate the category of the source of the bill.

The category, if known, may be used in the program's analysis, as some categories may have unique properties. For example, many wellbeing bills are no longer reported on credit rating reports. Therefore, a goal to raise a user's credit rating may lead the program to de-prioritize the payment of wellbeing bills.

In an embodiment, the computer program product may receive access to a wellbeing-savings account (“HSA”), which may be used to pay wellbeing bills. Other specific types of accounts may be used as well. In an embodiment, the payment amount may be transferred from the HSA to the user account and then to the payment recipient, for a wellbeing bill. In an embodiment, the payment may be made directly from the HSA or other specific account.

In an embodiment, the computer program product may also analyze past payment history of the user to make its determination(s). Past payment history may assist the program's algorithms in determining priority of payments as well as payment amounts. For example, a recurring bill that routinely accepts late payments without penalty or routinely accepts a percentage of the bill due and writes off the rest, may be treated the same way, even when the bill details do not include this information. Past history may also be used to determine the intent of the user when the user selects a particular goal. For example, when the user selects the goal of “do the same thing I have done in the past,” the program may analyze past history to determine how much the user has paid and in what order.

In an embodiment, the computer program may be encrypted. Any suitable encryption method may be used. As the program may deal with sensitive personal and financial information, robust (but useful) encryption may be a requirement. The program may encrypt any transmissions, the bills and their details, account details, and other information.

The program may require authentication by a user before transmitting any funds or performing any other actions. Any suitable authentication may be used. Stronger authentication (such as two-factor, biometric, or one-time password) may be more resource intensive but safer.

In an embodiment, each distinct source may be a separate source financial institution. For example, one credit card may be from one bank, a second card may be from a different bank, and a third card may be a store card. The program, before or after receiving the bills, may also receive access to the user's account(s) at these separate source financial institutions. For example, the program may retrieve a credit card bill from a separate source financial institution every month without the user being required to upload a particular bill.

In an embodiment, the user account may be located within a different financial institution than any source financial institution. For example, the user account may be with bank A, while each credit card may be from bank B, bank C, and store D, respectively. The program may receive access to user account(s) at each of these financial institutions or other entities. Access may allow the program to transfer funds between accounts, even across financial institutions.

In an embodiment, the program may automatically negotiate with each distinct source to procure one or more favorable terms for the user. Favorable terms may be identified based on the selected goals, or otherwise. The program may determine what is a favorable term or the user may indicate what is a favorable term. For example, the program may negotiate a later due date, a lower penalty, a lower interest rate, or even a lower total amount due, among other favorable terms. In an embodiment, the negotiation may be with a distinct source computer. In an embodiment, the negotiation may be with an individual employed by, contracted with, or located at the distinct source.

The program may negotiate directly, without user input or approval. Alternatively, the program may negotiate with user input and approval.

In an embodiment, the program may automatically search a network for a funding source, other than the user's account(s), for the user. The network may be the Internet.

A new, separate, funding source may assist the program in satisfying the user's selected goal(s). For example, if the user's account balance is too low to satisfy the goal(s) selected by the user, the program may search for, find, apply for, and receive alternate funding (e.g., a loan or line of credit) for the user. The program may apply for the alternate funding with permission from the user. The program may apply for the alternate funding without direct permission from the user.

An apparatus for automatic bill payment decisions is provided. The apparatus may include a central server and a user device. The central server may include a server communication link, a server processor, a server non-transitory memory, and other components.

The server non-transitory memory may be configured to store, inter alia, a server operating system and an automatic bill payment decisor application.

The user device may include a device communication link, a device processor, a biometric authenticator, a device graphical interface/display, device non-transitory memory, and other components.

The device non-transitory memory may be configured to a device non-transitory memory configured to store, inter alia, a device operating system and an interface in electronic communication over the device communication link with the automatic bill payment decisor application.

The decisor application may be configured to receive two or more bills. Each bill may originate from a distinct payment recipient/source and may be payable by the user. Each bill may also include information specifying an amount due, the payment recipient, a payment due date, payment information, as well as other information.

The decisor application may also be configured to provide two or more selectable wealth creation goals to the user. These goals may be displayed on the device graphical interface/display for the user to select.

The decisor application may also be configured to receive confirmation of authentication of the user through the biometric authenticator or other authentication method.

The application may receive one or more wealth creation goals selected by the user from the provided goals.

The application may receive access to a user account with funds owned by the user.

The application may determine, through an artificial intelligence/machine learning algorithm: which one of the two or more bills to pay first, and a payment amount to pay, as well as other determinations.

The program may transfer the payment amount from the user account to the payment recipient.

In an embodiment, the decisor application may analyze each of the two or more bills and the selected one or more wealth creation goals to satisfy the selected one or more wealth creation goals with the payment amount and order of payment.

In an embodiment, the decisor application may also automatically negotiate with each payment recipient to reduce the amount due or for some other benefit for the user.

In an embodiment, the decisor application may also receive access to a revolving line of credit available to the user, or some other funding source.

A method for automatically ranking and applying payments to a plurality of bills is provided. The method may include the following steps: Receiving, at an automatic bill payment decisor application located at a central server, two or more bills. Each bill may originate from a distinct payment recipient, may be payable by a user, may include data specifying an amount due, the payment recipient, a payment due date, payment information, and other data. Providing two or more selectable wealth-creation goals to the user displayed on a device graphical interface available to the user. Authenticating the user. Receiving one or more wealth-creation goals selected by the user from the list provided to the user. Receiving access to a user account with funds owned by the user. Determining, through an artificial intelligence/machine learning algorithm, which one of the two or more bills to pay first as well as a payment amount to pay. Transferring the payment amount from the user account to the payment recipient.

In an embodiment, the step of determining may include: analyzing each of the two or more bills, the selected one or more wealth creation goals, the user account, past history of the user, and other information.

In an embodiment, the method may also include the step of automatically negotiating with each payment recipient to procure one or more favorable terms for the user.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

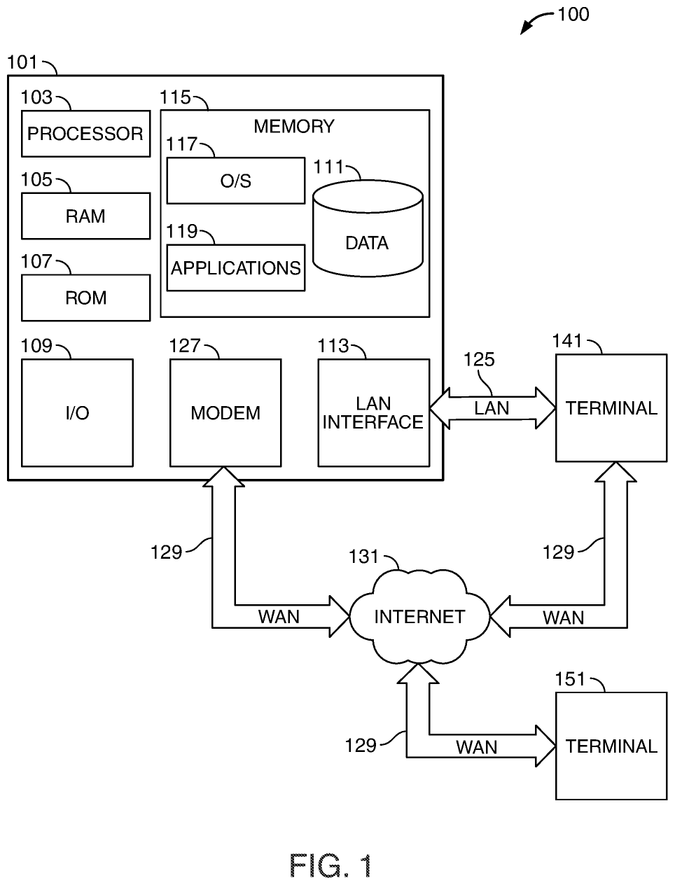

In accordance with principles of the disclosure, FIG. 1 shows an illustrative block diagram of apparatus 100 that includes a computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein, or a human/entity.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as an automatic payment decisor application and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as an automatic payment decisor application and security protocols) along with any other data 111 (historical bot data, configuration files) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology—e.g., a hard drive or other non-transitory memory. The memory may store software including an operating system and any application(s) (such as an automatic payment decisor application and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, IoT devices, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an automatic payment decisor application and security protocols, as well as other programs. In an embodiment, one or more programs, or aspects of a program, may use one or more AI/ML algorithm(s). The various tasks may be related to automatically deciding which bill to pay in what amount and making the payment(s) as decided.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application, such as an automatic payment decisor application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other Computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

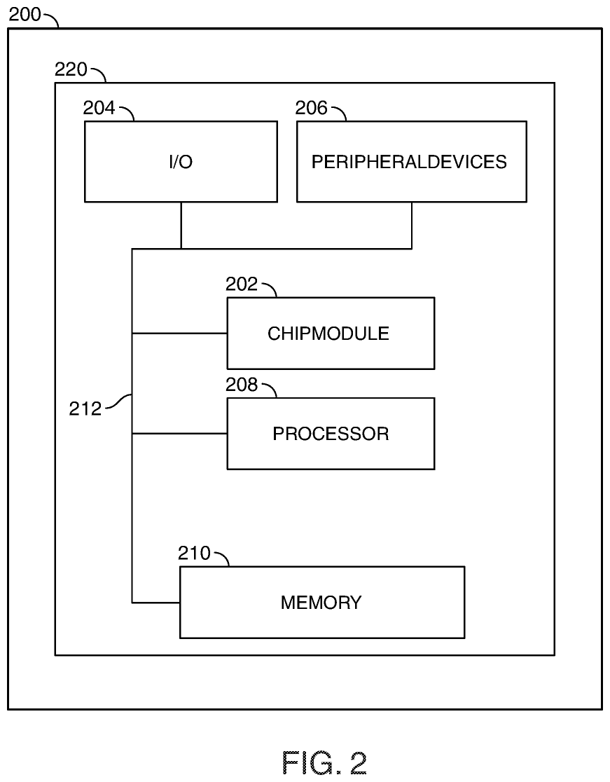

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1, 3, and 6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an display (LCD, LED, OLED, etc.), a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

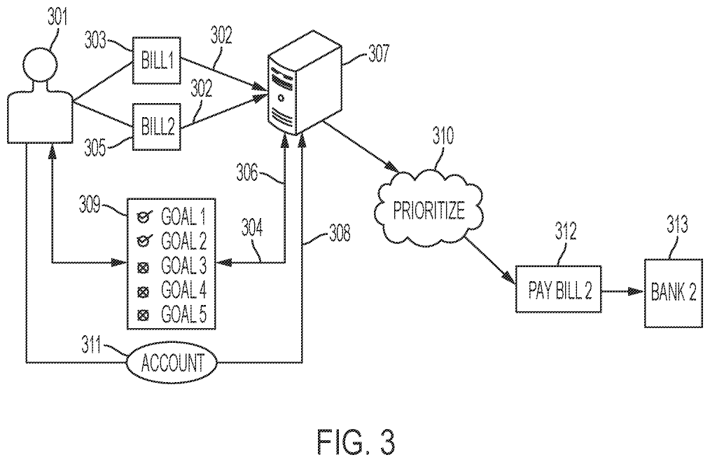

FIG. 3 shows an illustrative schematic in accordance with principles of the disclosure. Apparatus may include any of the apparatus odd-numbered 301 through 313, among other components. Methods may include some or all of the method steps even numbered 302 through 312, as well as additional steps. Methods may include the steps illustrated in FIG. 3 in an order different from the illustrated order. The illustrative method shown in FIG. 3 may include one or more steps performed in other figures or described herein. Steps 302 through 312 may be performed on the apparatus shown in FIGS. 1-2, and 6 or other apparatus shown in other figures or described elsewhere.

A user 301 may be responsible for bills 303 and 305. At step 302, the user 301 may transmit the bills 303 and 305 to a server 307. Server 307 may include an automatic payment decisor application.

The automatic payment decisor application may transmit, at step 304, a list of selectable goals 309 to the user 301. At step 306, the user 301 may select one or more goals 309 and transmit the selection to the server 307.

At step 308, the user 301 may grant the server 307 access to a user account 311, which may include funds to pay bills 303 and 305.

At step 310, the automatic payment decisor application on server 307 may analyze the bills 303 and 305, along with the selected goals 309, and prioritize which bill to pay when and in what amount.

At step 312, the automatic payment decisor application on server 307 may pay the prioritized bill to the payment recipient 313, which may be financial institution or other entity.

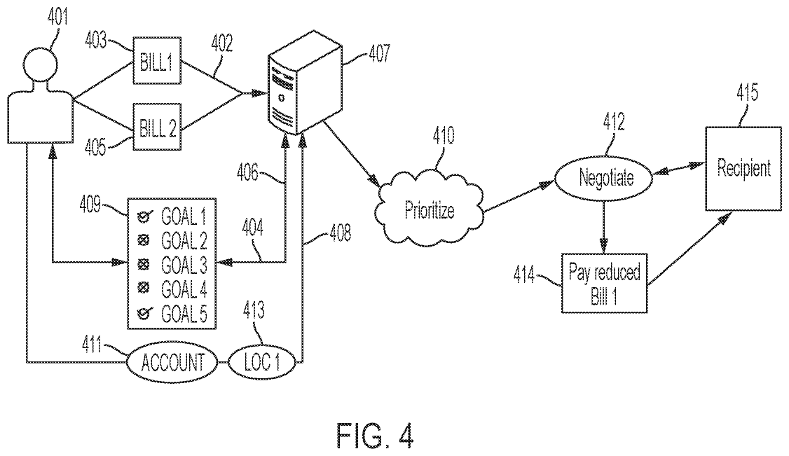

FIG. 4 shows an illustrative schematic in accordance with principles of the disclosure. Apparatus may include any of the apparatus odd-numbered 401 through 415, among other components. Methods may include some or all of the method steps even numbered 402 through 414, as well as additional steps. Methods may include the steps illustrated in FIG. 4 in an order different from the illustrated order. The illustrative method shown in FIG. 4 may include one or more steps performed in other figures or described herein. Steps 402 through 414 may be performed on the apparatus shown in FIGS. 1-2, and 6 or other apparatus shown in other figures or described elsewhere.

A user 401 may be responsible for bills 403 and 405. At step 402, the user 401 may transmit the bills 403 and 405 to a server 407. Server 407 may include an automatic payment decisor application.

The automatic payment decisor application may transmit, at step 404, a list of selectable goals 409 to the user 401. At step 406, the user 401 may select one or more goals 409 and transmit the selection to the server 407.

At step 408, the user 401 may grant the server 407 access to a user account 411 and revolving line-of credit 413, which may include funds to pay bills 403 and 405.

At step 410, the automatic payment decisor application on server 407 may analyze the bills 403 and 405, along with the selected goals 409, and prioritize which bill to pay when and in what amount.

At step 412, the automatic payment decisor application on server 407 may negotiate for one or more favorable terms with bill payment recipient 415. The negotiation may be at the direction of user 401 or automatically, without direction, by the automatic payment decisor application on server 407. The negotiation may result in favorable payment terms.

At step 414, the automatic payment decisor application on server 407 may pay the prioritized and negotiated bill to the payment recipient 415, which may be financial institution or other entity.

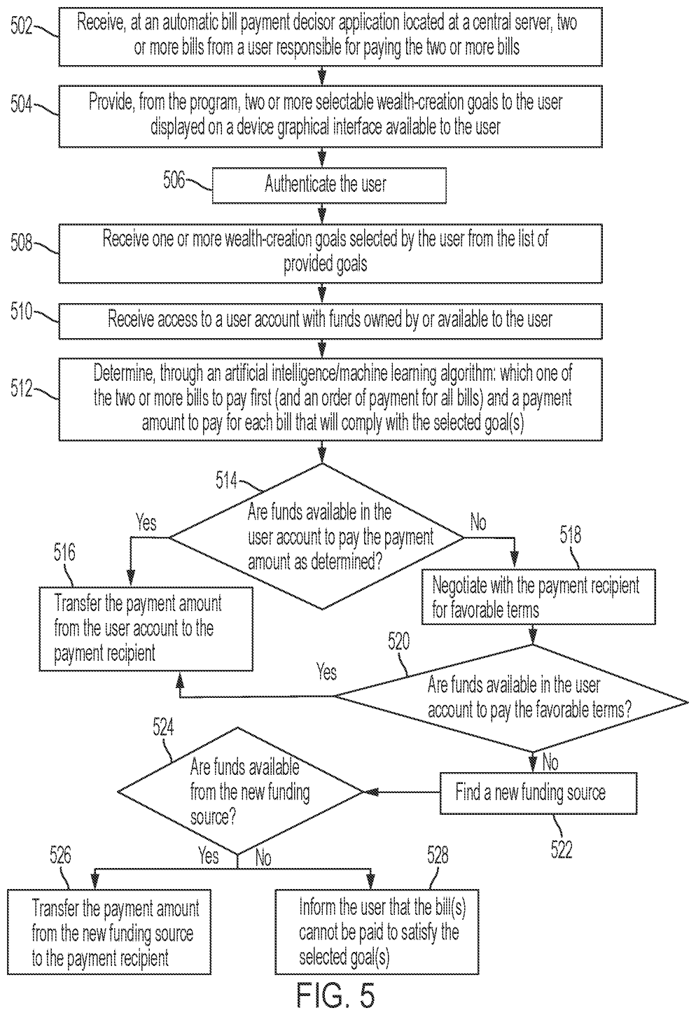

FIG. 5 shows an illustrative flowchart in accordance with principles of the disclosure. Methods may include some or all of the method steps numbered 502 through 528. Methods may include the steps illustrated in FIG. 5 in an order different from the illustrated order. The illustrative method shown in FIG. 5 may include one or more steps performed in other figures or described herein. Steps 502 through 528 may be performed on the apparatus shown in FIGS. 1-3, 6 or other apparatus.

At step 502, an automatic bill payment decisor application on a centralized server may receive two or more bills from a user responsible for paying the bills.

At step 504, the program may provide the user with two or more selectable wealth creation goals. The list of selectable wealth creation goals may be displayed on a device graphical user interface that is available to the user (such as a smartphone or other user device).

At step 506, the program may authenticate the user. The user may be authenticated through the user device in step 504 or through another user device.

At step 508, the program may receive one or more goals selected by the user.

At step 510, the program may receive access to a user account. The user account may or may not have funds available to pay all the bills received at step 502 in full.

At step 512, the program may determine, through an artificial intelligence/machine learning algorithm: which one of the two or more bills to pay first (and an order of payment for all bills) and a payment amount to pay for each bill that will comply with the selected goal(s).

At step 514, the program may determine if there are enough funds available in the user account to pay the payment amount determined at step 512.

If there are enough funds, at step 516, the program may transfer the payment amount from the user account to the payment recipient.

If there are not enough funds, at step 518, the program may automatically negotiate with the payment recipient to attempt to receive favorable terms (lower payment amount, later due date, etc.).

After negotiation, at step 520 the program may determine if there are now enough funds in the user account to pay the favorable terms. If yes, the program, at step 516, may transfer the new negotiated payment amount to the payment recipient.

If there are still not enough funds to pay the negotiated payment amount, at step 522, the program may attempt to find a new funding source for the user.

At step 524, the program may determine if there are funds available from the new funding source to pay the payment amount. If yes, at step 526, the program may transfer the payment amount from the new funding source to the payment recipient.

If no, at step 528, the program may inform the user that the program cannot satisfy the selected goal(s).

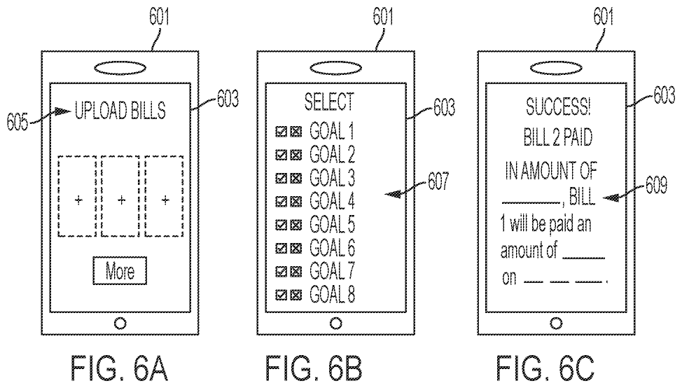

FIGS. 6A, 6B, and 6C show exemplary display screens in accordance with principles of the disclosure.

A user device 601 may include a graphical display screen 603. The display screen 603 may be touch sensitive.

Screen 605 shows an exemplary graphical screen where a user (not shown) may upload two or more bills to an automatic bill payment decisor application on a centralized server.

Screen 607 shows an exemplary screen where a user (not shown) may select one or more wealth creation goals. The list of goals may be transmitted from the automatic bill payment decisor application to the user device 601.

Screen 609 shows an exemplary screen that the automatic bill payment decisor application may transmit to the user device 601 informing the user that the program was successful. The program may pay a determined payment amount for one bill as well as schedule payments for any remaining bills.

Thus, apparatus and methods for automating bill payment decisions and bill payments are provided. Persons skilled in the art will appreciate that the present invention can be practiced by other than the described embodiments, which are presented for purposes of illustration rather than of limitation.

What is claimed is:

1. An automatic bill payment decisor computer program product, the computer program product comprising executable instructions, the executable instructions when executed by a processor on a computer system:
receive two or more bills, each originating from a distinct source and payable by a user;
provide two or more selectable wealth creation goals to the user;
receive one or more wealth creation goals selected by the user;
receive access to a user account with funds owned by the user;
determine, through an artificial intelligence/machine learning algorithm, a determination of:
which one of the two or more bills to pay first; and
a payment amount to pay; and
transfer the payment amount from the user account to a payment recipient;
wherein:
each of the two or more bills comprises data specifying:
an amount;
the payment recipient;
a payment due date; and
payment information; and
the determination analyzes at least:
each of the two or more bills; and
the selected one or more wealth creation goals to satisfy the selected one or more wealth creation goals with:
the payment amount; and
a determined order of payment.

2. The automatic bill payment decisor computer program product of claim 1 wherein each of the two or more bills further comprises data specifying an interest rate.

3. The automatic bill payment decisor computer program product of claim 1 wherein the computer program product receives access to a revolving line of credit.

4. The automatic bill payment decisor computer program product of claim 3 wherein the payment amount is transferred from the revolving line of credit to the user account and then to the payment recipient.

5. The automatic bill payment decisor computer program product of claim 1 wherein one or more distinct source of one or more of the two or more bills is a wellbeing provider.

6. The automatic bill payment decisor computer program product of claim 5 wherein computer program product receives access to a wellbeing-savings account (“HSA”).

7. The automatic bill payment decisor computer program product of claim 6 wherein the payment amount is transferred from the HSA to the user account and then to the payment recipient.

8. The automatic bill payment decisor computer program product of claim 1 wherein the determination further analyzes past payment history of the user.

9. The automatic bill payment decisor computer program product of claim 1 wherein the computer program is encrypted.

10. The automatic bill payment decisor computer program product of claim 1 wherein each distinct source is a separate source financial institution.

11. The automatic bill payment decisor computer program product of claim 10 wherein the user account is not located within a source financial institution.

12. The automatic bill payment decisor computer program product of claim 1 wherein the executable instructions automatically negotiate with each distinct source to procure one or more favorable terms for the user.

13. The automatic bill payment decisor computer program product of claim 1 wherein the executable instructions automatically search a network for a funding source for the user.

14. An apparatus for automatic bill payment decisions, the apparatus comprising:
a central server, the central server including:
a server communication link;
a server processor; and
a server non-transitory memory configured to store at least:
a server operating system; and
an automatic bill payment decisor application; and
a user device belonging to a user, the user device including:
a device communication link;
a device processor;
a biometric authenticator;
a device graphical interface; and
a device non-transitory memory configured to store at least:
a device operating system; and
an interface in electronic communication over the device communication link with the automatic bill payment decisor application;
wherein the decisor application:
receives two or more bills, each originating from a distinct payment recipient and payable by the user;
provides two or more selectable wealth-creation goals to the user displayed on the device graphical interface;
receives confirmation of authentication of the user through the biometric authenticator;
receives one or more wealth creation goals selected by the user;
receives access to a user account with funds owned by the user;
determines, through an artificial intelligence/machine learning algorithm:
which one of the two or more bills to pay first; and
a payment amount to pay; and
transfers the payment amount from the user account to a payment recipient; and
wherein each of two or more bills includes:
an amount due;
the payment recipient;
a payment due date; and
payment information.

15. The apparatus of claim 14 wherein the decisor application analyzes each of the two or more bills and the selected one or more wealth creation goals to satisfy the selected one or more wealth creation goals with the payment amount and order of payment.

16. The apparatus of claim 14 wherein the decisor application further automatically negotiates with each payment recipient to reduce the amount due.

17. The apparatus of claim 14 wherein the decisor application further receives access to a revolving line of credit available to the user.

18. A method for automatically ranking and applying payments to a plurality of bills, the method comprising the steps of:
receiving, at an automatic bill payment decisor application located at a central server, two or more bills, wherein each bill:
originates from a distinct payment recipient;
is payable by a user; and
includes:
an amount due;
the payment recipient;
a payment due date; and
payment information;
providing two or more selectable wealth-creation goals to the user displayed on a device graphical interface available to the user;
authenticating the user;
receiving one or more wealth-creation goals selected by the user;
receiving access to a user account with funds owned by the user;
determining, through an artificial intelligence/machine learning algorithm:
which one of the two or more bills to pay first; and
a payment amount to pay; and
transferring the payment amount from the user account to the payment recipient.

19. The method of claim 18 wherein the step of determining includes:
analyzing:
each of the two or more bills;
the selected one or more wealth creation goals;
the user account; and
past history of the user.

20. The method of claim 18 further comprising the step of automatically negotiating with each payment recipient to procure one or more favorable terms for the user.
